(19) United States
(12) Patent Application Publication
(10) Pub. No.: US 2026/0004616 A1
(43) Pub. Date: Jan. 1, 2026

(54) APPARATUSES, COMPUTER-IMPLEMENTED METHODS, AND COMPUTER PROGRAM PRODUCTS FOR IMPLEMENTING VEHICLE COMPONENT LIFECYCLE DATA

(71) Applicant: Honeywell International Inc., Charlotte, NC (US)

(72) Inventor: Rushoth Kumar M C, Bangalore (IN)

(21) Appl. No.: 18/796,995

(22) Filed: Aug. 7, 2024

(30) Foreign Application Priority Data
Jun. 26, 2024 (IN) 202411048927

(51) Int. Cl. G07C 5/00; G07C 5/08

(52) U.S. Cl. CPC G07C 5/006; G07C 5/0808; G07C 5/0825

(57) ABSTRACT

Embodiments of the disclosure provide for persistent accumulation and maintenance of lifecycle data for vehicle components. In the context of a method, the method includes initializing, in a data store, a count of occurrences of an event associated with an event condition for a vehicle component installed on a vehicle, the count of occurrences of the event being maintained at the data store for a lifecycle of the vehicle component; storing, in the data store, a definition for the event condition; obtaining, from an onboard sensor or system, vehicle data associated with operation of the vehicle; determining that a subset of the vehicle data meets the event condition; in response, updating the count of occurrences at the data store; and causing rendering of the updated count of occurrences on a computing device external to the vehicle.

### CROSS REFERENCE TO RELATED APPLICATIONS

This application claims the benefit of and priority to India application No. 202411048927, filed Jun. 26, 2024, entitled “APPARATUSES, COMPUTER-IMPLEMENTED METHODS, AND COMPUTER PROGRAM PRODUCTS FOR IMPLEMENTING VEHICLE COMPONENT LIFECYCLE DATA,” the disclosure of which is incorporated herein by reference in its entirety.

### TECHNOLOGICAL FIELD

Embodiments of the present disclosure are generally directed to accumulating and maintaining data for a lifecycle of a vehicle component.

### BACKGROUND

Typical approaches to tracking vehicle component integrity rely upon inspection by maintenance teams. For example, vehicle health monitoring may be performed by inspecting and recording the status of its components. However, personnel responsible for monitoring vehicle health may have limited knowledge as to the full maintenance history of each component. The reduced scope of information upon which component replacement is based may result in inaccurate maintenance monitoring and substandard servicing of vehicle components.

Applicant has discovered various technical problems associated with maintenance monitoring of vehicle components. Through applied effort, ingenuity, and innovation, Applicant has solved many of these identified problems by developing the embodiments of the present disclosure, which are described in detail below.

### BRIEF SUMMARY

In general, embodiments of the present disclosure herein provide for accumulation and persistent maintenance of data associated with vehicle component health. For example, embodiments of the present disclosure provide for detecting instances which a component experiences an event with potential to impact component health. Further, embodiments of the present disclosure may store and update occurrence counts to track the quantity of instances in which a component experiences a health-impacting event. The occurrent counts may be provided to maintenance personnel, vehicle operators, and/or the like to enable maintenance monitoring of the vehicle and its components. Other implementations for implementing persistent maintenance of data for vehicle and vehicle component lifecycles will be, or will become, apparent to one with skill in the art upon examination of the following figures and detailed description. It is intended that all such additional implementations be included within this description be within the scope of the disclosure, and be protected by the following claims.

In accordance with a first aspect of the disclosure, a computer-implemented method for improved vehicle maintenance monitoring is provided. The computer-implemented method is executable utilizing any of a myriad of computing device(s) and/or combinations of hardware, software, firmware. In some example embodiments an example computer-implemented method includes initializing, in at least one data store, a count of occurrences of a respective event associated with at least one event condition for a component installed on a vehicle, wherein the count of occurrences of the respective event is maintained at the data store for a lifecycle of the component; storing, in the at least one data store, a respective definition for the at least one event condition; obtaining, from at least one sensor or system aboard the vehicle, vehicle data associated with operation of the vehicle; determining that at least a subset of the vehicle data meets the at least one event condition for the component; in response to the determination, updating the count of occurrences of the respective event at the at least one data store; and causing rendering of the updated count of occurrences on a computing device external to the vehicle to enable maintenance monitoring of the component.

In some embodiments, the method further comprises resetting the count of occurrences of the respective event in the at least one data store in response to replacement of the component. In some embodiments, the method further comprises obtaining a value of at least one historical count of occurrences of the respective event for a replacement component; and updating the count of occurrences of the respective event based at least in part on the value of the at least one historical count of occurrences.

In some embodiments, the at least one data store comprises a first data store aboard the vehicle and a second data store remote to the vehicle. In some embodiments, the first data store comprises the respective definition for the at least one event condition and the second data store comprises the count of occurrences of the respective event for the component. In some embodiments, the method further comprises provisioning to the vehicle the respective definition for the at least one event condition; and receiving from the vehicle at least the subset of the vehicle data determined to meet the at least one event condition for the component. In some embodiments, the method further comprises initializing the respective definition at the first data store to cause a vehicle management system aboard the vehicle to provision the vehicle data to the apparatus in response to the vehicle data meeting a least a portion of the respective definition for the at least one event condition.

In some embodiments, the method further comprises determining the updated count of occurrences for the respective event for the component meets a replacement threshold; and in response to the determination, provisioning to the computing device an instruction to replace the component. In some embodiments, the method further comprises receiving from the computing device a request comprising at least one of an increment or a decrement to the updated count of occurrences; and modifying the updated count of occurrences based at least in part on the request. In some embodiments, the method further comprises receiving from the computing device a request comprising at least one modification to the respective definition for the at least one event condition; and updating the respective definition based at least in part on the at least one modification.

In some embodiments, the respective definition indicates at least one threshold for at least one component parameter. In some embodiments, the at least one component parameter comprises a fault state for the component. In some embodiments, the fault state comprises at least one of depowered, underpowered, or clogged. In some embodiments, the at least one component parameter comprises at least one of hydraulic pressure, oil pressure, moisture level, or temperature. In some embodiments, the at least one component parameter comprises at least one of applied load, torque, shock intensity, vibration intensity, vibration frequency, or vibration duration. In some embodiments, the respective definition indicates at least one threshold for at least one of vehicle attitude, vehicle speed, or braking.

In some embodiments, the method further comprises provisioning to the vehicle the updated count of occurrences. In some embodiments, the method further comprises receiving from the computing device at least one of a vehicle identifier or a system identifier; determining a plurality of components associated with the vehicle identifier or the system identifier;

retrieving, from the at least one data store, a current count of occurrences for at least one event condition associated with a respective component; and provisioning to the computing device a report comprising the respective current counts of occurrences of the at least one event condition for the plurality of components. In some embodiments, the method further comprises generating a ranking of the plurality of components based at least in part on the respective current counts of occurrences of the at least one condition, wherein a top-ranked entry of the ranking comprises a component associated with a greatest quantity of occurrences of the at least one event condition; and provisioning to the computing device a respective component identifier for a top-ranked subset of the ranking.

In accordance with another aspect of the present disclosure, a computing apparatus for improved vehicle maintenance monitoring is provided. The computing apparatus in some embodiments includes at least one processor and at least one non-transitory memory, the at least non-transitory one memory having computer-coded instructions stored thereon. The computer-coded instructions in execution with the at least one processor causes the apparatus to perform any one of the example computer-implemented methods described herein. In some other embodiments, the computing apparatus includes means for performing each step of any of the computer-implemented methods described herein.

In accordance with another aspect of the present disclosure, a computer program product for improved vehicle maintenance monitoring is provided. The computer program product in some embodiments includes at least one non-transitory computer-readable storage medium having computer program code stored thereon. The computer program code in execution with at least one processor is configured for performing any one of the example computer-implemented methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a networked environment that may be specially configured within which embodiments of the present disclosure may operate.

FIG. 2 illustrates a block diagram of an example apparatus that may be specially configured in accordance with at least some example embodiments of the present disclosure.

FIG. 3 illustrates an example data architecture in accordance with at least some example embodiments of the present disclosure.

FIG. 4 illustrates an example workflow for implementing persistent vehicle data in accordance with at least some example embodiments of the present disclosure.

FIG. 5 illustrates a flowchart depicting operations of an example process for implementing persistent vehicle data in accordance with at least some example embodiments of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

Embodiments of the present disclosure provide a myriad of technical advantages in the technical field of vehicle maintenance monitoring. Typically, vehicle component health is tracked by collecting and storing service logs and inspection reports that are manually generated by maintenance personnel. For example, in an aerial context, lifecycle data for a vehicle may be limited to records of repairs and inspections performed on a vehicle. In such approaches, the activities and phenomena that occur on the vehicle and impact component health remain undocumented. For example, in an aerial context, records of maintenance for a vehicle's landing gear may be limited to documentations of ground inspections and component repairs or replacements. In such instances, the events that may adversely impact component health and precipitate repair needs may be unrecorded in the maintenance records.

Embodiments of the present disclosure overcome the technical challenges of implementing persistent lifecycle data by detecting component-impacting events and tracking such occurrences in a persistent storage medium. The various embodiments of the present disclosure may improve understanding of current and historical component health by maintaining occurrence counts indicative of the number of instances in which a component has experience a health-impacting event. For example, various embodiments of the disclosure may configure a vehicle to detect and report instances in which data associated with operation of a vehicle meets a respective definition for one or more event conditions. The various embodiments of the present disclosure may update and store occurrence counts for vehicle components for their respective lifecycles, the lifecycle of the vehicle, and/or the like. By doing so, the techniques described herein may increase visibility and understanding of vehicle health on a component-by-component basis. In this manner, the various embodiments of the present disclosure may enable maintenance personnel to persistently monitor the health of components in substantially real-time and more efficiently organize resources for timely performance of maintenance and replacement operations.

### Definitions

“Vehicle” refers to any apparatus that traverses throughout an environment by any mean of travel. In some contexts, a vehicle transports goods, persons, and/or the like, or traverses itself throughout an environment for any other purpose, by means of air, sea, or land. In some embodiments, a vehicle is ground-based, air-based, water-based, space-based (e.g., outer space or within an orbit of a planetary body, a natural satellite, or artificial satellite), and/or the like. In some embodiments, the vehicle is an aerial vehicle capable of air travel. Non-limiting examples of aerial vehicles include urban air mobility vehicles, drones, helicopters, fully autonomous air vehicles, semi-autonomous air vehicles, airplanes, orbital craft, spacecraft, rotorcraft, and/or the like. In some embodiments, the vehicle is piloted by a human operator onboard the vehicle. For example, in an aerial context, the vehicle may be a commercial airliner operated by a flight crew. In some embodiments, the vehicle is remotely controllable such that a remote operator may initiate and direct movement of the vehicle. Additionally, in some embodiments, the vehicle is unmanned. For example, the vehicle may be a powered, aerial vehicle that does not carry a human operator and is piloted by a remote operator using a control station. In some embodiments, the vehicle is an aquatic vehicle capable of surface or subsurface travel through and/or atop a liquid medium (e.g., water, water-ammonia solution, other water mixtures, and/or the like). Non-limiting examples of aquatic vehicles include unmanned underwater vehicles (UUVs), surface watercraft (e.g., boats, jet skis, and/or the like), amphibious watercraft, hovercraft, hydrofoil craft, and/or the like. As used herein, vehicle may refer to vehicles associated with advanced air mobility (AAM).

“AAM” refers to advanced air mobility, which includes all aerial vehicles and functions for aerial vehicles that are capable of performing vertical takeoff and/or vertical landing procedures. Non-limiting examples of AAM aerial vehicles include passenger transport vehicles, cargo transport vehicles, small package delivery vehicles, unmanned aerial system services, autonomous drone vehicles, and ground-piloted drone vehicles, where any such vehicle is capable of performing vertical takeoff and/or vertical landing.

“Vehicle component” refers to any number of parts, systems, modules, and/or the like of a vehicle. For example, a vehicle component may include a hydraulic press filter, hydraulic valve, or, collectively, a hydraulic system. As another example, a vehicle component may include an electrical system or one or more modules or elements thereof, such as a fuse, switch, circuit breaker, battery, and/or the like. In another example, a vehicle component may include an engine, primary nozzle, thrust reverser, bleed air system, or, collectively, a power unit. In some embodiments, a vehicle component includes one or more fasteners, fittings, connectors, and/or the like. In various embodiments, the present methods, apparatuses, and computer program products enable persistent collection and maintenance of data associated with vehicle component health.

“Persistent” refers to retention of information for a lifecycle of a vehicle component. For example, persistent maintenance of data associated with vehicle component health may include retaining said data from its origin until permanent decommissioning or disuse of the associated vehicle component. In various embodiments, persistent maintenance of data associated with vehicle component health includes collecting and storing records of component-impacting events. For example, the present methods, apparatuses, and computer program products may continuously monitor for and record occurrences of instances in which one or more parameters of a vehicle component meet predefined criteria, such as exceeding a threshold value or range. The record of occurrences may be maintained in association with the vehicle component until termination of the component lifecycle, which may include removal of the component from the vehicle or final decommissioning of the component. For example, the recorded events may be embodied as one or more counts of occurrences that are maintained and iterated upon throughout utilization of the component on one or more vehicles. Additionally, or alternatively, a record of the occurrences may be maintained in association with the vehicle within which the component is installed. In such contexts, the record of occurrences may be maintained for an interval comprising the installation and ultimate removal of the vehicle component.

“Event” refers to any activity, interaction, phenomena, and/or the like that may be experienced by or applied to a vehicle component. In some embodiments, an event includes an instance in which a parameter of a vehicle component meets, exceeds, or falls below a particular value. As an example, in the context of a hydraulic system or element thereof, an event may include an instance of overheating or overpressure. In some embodiments, an event includes an instance in which a vehicle component becomes inoperable, malfunctions, or experiences an error state. For example, in the context of a hydraulic return filter, an event may include a clog. In some embodiments, an event is associated with one or more event conditions. For example, an overheat event for a hydraulic system may be associated with an event condition comprising hydraulic fluid temperature. In such contexts, the overheat event may defined as excess temperature of the component or fluid passing through the component, which may be measured by one or more sensors. For example, the excess temperature may be configured as a threshold to which measurements of hydraulic fluid temperature are compared. In another example, an overpressure event for a hydraulic system may be associated with an event condition comprising hydraulic fluid pressure. In such contexts, the component parameter of hydraulic fluid pressure may be compared to a threshold to determine whether the overpressure event occurred.

“Condition” refers to any parameter or status of a vehicle component, vehicle, vehicle operator, and/or the like. For example, a condition may include one or more component parameters, such as fluid pressure (e.g., hydraulic pressure, oil pressure, water pressure, and/or the like), temperature, moisture level, power consumption, corrosion, and/or the like. As another example, a condition may include one or more fault states, such as depowered, underpowered, clogged, unresponsive, and/or the like. In some embodiments, a condition includes one or more vehicle parameters. For example, a vehicle parameter may include vehicle orientation (e.g., horizontal attitude, vertical attitude, and/or the like), speed, acceleration, and/or the like. In another example, a vehicle parameter may include one or more statuses of the vehicle, such as landing, taking off, taxiing, braking, and/or the like.

“Vehicle data” refers to any information associated with operation or performance of a vehicle, one or more vehicle components, a vehicle operator, and/or the like. In some embodiments, vehicle data includes unique identifying information for a vehicle, vehicle component, vehicle operator, and/or the like. For example, vehicle data may include respective identifiers by which the vehicle or one or more vehicle components may be identified. In various embodiments, vehicle data may include component parameters, vehicle parameters, and/or the like. For example, vehicle data may include readings from one or more sensors or systems of the vehicle. In some embodiments, vehicle data includes measurements of temperature, pressure, flow rate, volume, force (e.g., vibration, shock, acceleration, applied load, and/or the like), mass, position, displacement, and/or the like. In some embodiments, vehicle data includes statuses of one or more vehicle components or systems comprising the one or more vehicle components. For example, vehicle data may include a fault of a system or vehicle component, such as underpowered, depowered, clogged, blocked, dislodged, disconnected, unresponsive, and/or the like. In various embodiments, the terms vehicle data and “lifecycle data” are used interchangeably herein.

### Example Systems and Apparatuses of the Disclosure

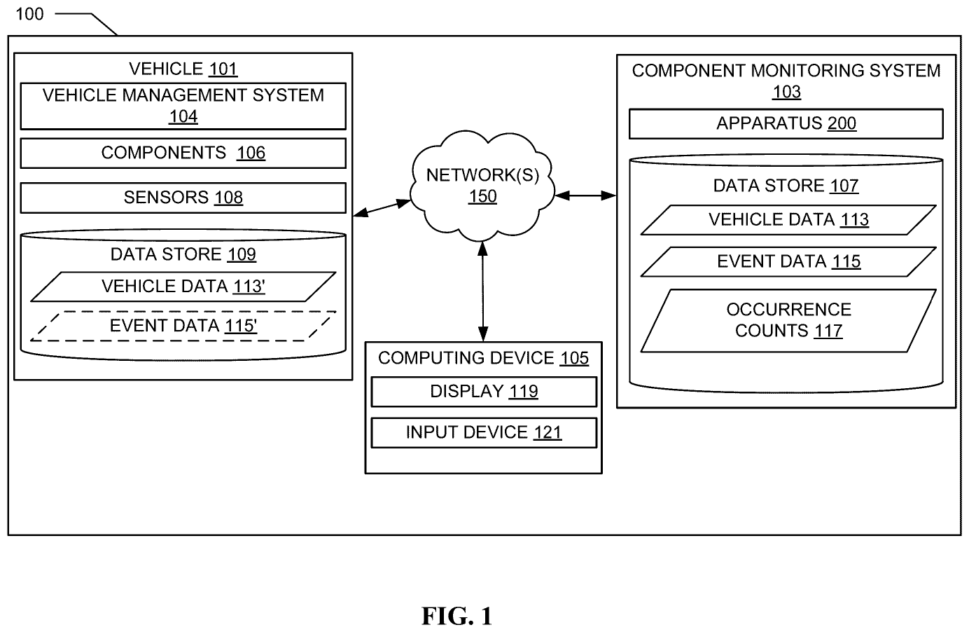

FIG. 1 illustrates a block diagram of a networked environment that may be specially configured within which embodiments of the present disclosure may operate. Specifically, FIG. 1 depicts an example networked environment 100. As illustrated, the networked environment 100 includes one or more vehicles 101, a component monitoring system 103, and one or more computing devices 105.

In various embodiments, the component monitoring system 103 is configured to accumulate and persistently maintain data indicative of vehicle component health. For example, the component monitoring system 103 may obtain and store, for a lifecycle of a component 106, one or more occurrence counts 117 of one or more events determined to have occurred respective to the component 106. The event may include an instance in which one or more parameters of the component 106, vehicle 101, and/or the like meets a threshold. For example, an occurrence count 117 may indicate a quantity of instances in which a component 106 experienced a shock, vibration, and/or the like in excess of one or more thresholds for intensity, frequency, duration, and/or the like. Additionally, or alternatively, the event may include an instance in which one or more statuses of the component 106, a system associated with the component 106, or the vehicle 101 are detected. For example, the event may include an instance in which the vehicle 101 exceeds a threshold for acceleration, bank angle, turbulence, and/or the like. As another example, the event may include an instance in which a component 106 is clogged, disconnected, depowered, underpowered, unresponsive, and/or the like.

In some embodiments, the component monitoring system 103 is configured to initialize a respective occurrence count 117 for one or more events in response to installation of a component 106 within a vehicle 101. For example, in response to installation of a new hydraulic return filter within a vehicle, the component monitoring system 103 may initialize an occurrence count 117 at a value of 0. In some embodiments, the component monitoring system 103 stores an association between a component 106 and a vehicle 101 within which the component 106 is installed. In some embodiments, in instances in which a component 106 is removed from a first vehicle 101 and installed in a second vehicle 101, the component monitoring system 103 removes the association between the component 106 and the first vehicle 101 and generates and stores a new association between the component 106 and the second vehicle 101. In such contexts, the component monitoring system 103 may continue maintaining and updating previously initialized occurrence counts 117 for the component to enable persistent and accurate maintenance monitoring of the component 106.

In some embodiments, the component monitoring system 103 is configured to store and maintain event data 115 for defining and detecting one or more events. For example, the component monitoring system 103 may store definitions of event conditions for one or more events that may be experienced by a component 106. In some embodiments, the component monitoring system 103 is configured to provision event data 115 to a vehicle 101 for storage in one or more data stores 109 (e.g., as event data 115′). In doing so, the component monitoring system 103 may enable the vehicle management system 104 to detect occurrences of events at least in part by determining whether vehicle data 113′ meets one or more event conditions. In instances where the vehicle management system 104 determines that a respective event condition for one or more events is met, the component monitoring system 103 may receive from the vehicle management system 104 an indication that the one or more events occurred. Additionally, or alternatively, the component monitoring system 103 may receive at least the subset of the vehicle data 113′ determined to have met the one or more event conditions.

Additionally, or alternatively, in some embodiments, the component monitoring system 103 is configured to determine whether vehicle data 113 associated with operation of the vehicle 101 meets one or more event conditions for one or more components 106. For example, the component monitoring system 103 may receive vehicle data 113 indicative of one or more statuses, pressures, and/or the like of a vehicle hydraulic system. The component monitoring system 103 may determine that the vehicle data 113 meets one or more event conditions associated with a filter clog event for a hydraulic return filter. In response, the component monitoring system 103 may increment an occurrence count 117 of the filter clog event for the hydraulic return filter.

In some embodiments, the component monitoring system 103 is configured to provision occurrence counts 117, event data 115, vehicle data 113, and/or the like to one or more computing devices 105. For example, the component monitoring system 103 may provision to a computing device 105 respective occurrence counts 117 of one or more events for one or more components 106 installed within a vehicle 101. In doing so, the component monitoring system 103 may provide a persistent overview of potential impactors to component health over the lifecycle of the component 106. In some embodiments, the component monitoring system 103 receives from a computing device 105 a request for occurrence counts, the request comprising a vehicle identifier, system identifier, component identifier, and/or the like. In some embodiments, the component monitoring system 103 provisions to the computing device 105 one or more occurrence counts 117 for one or more components 106 associated with the vehicle identifier, system identifier, component identifier, and/or the like. In doing so, the component monitoring system 103 may enable vehicle maintainers to rapidly access component health information respective to an entire vehicle, one or more systems of the vehicle, one or more components 106, and/or the like.

In various embodiments, the component monitoring system 103 is configured to cause the computing device 105 to render graphical user interfaces (GUIs) on one or more displays 119. For example, the component monitoring system 103 may cause rendering of a GUI comprising one or more occurrence counts 117 of events for one or more components 106. In some embodiments, the component monitoring system 103 cause rendering of vehicle data 113, event data 115, and/or the like on the display 119. For example, the component monitoring system 103 may cause rendering of an occurrence count 117 for an event, a definition of an event condition for the event, and one or more subsets of vehicle data 113 determined to meet the event condition.

In some embodiments, the component monitoring system 103 is configured to modify an occurrence count 117, event condition definition, and/or the like based at least in part on user input received at the computing device 105. For example, the computing device 105 may receive a user input comprising a request to increment or decrement an occurrence count 117 by an inputted value. The component monitoring system 103 may receive the request from the computing device 105 and, in response, modify the occurrence count 177 based at least in part on the inputted value. In doing so, the component monitoring system 103 may correct false positives, false negatives, and/or the like.

In some embodiments, the component monitoring system 103 is configured to receive from the computing device 105 a request to modify criteria for detecting one or more event conditions. The component monitoring system 103 may modify event data 115 based at least in part on the request to adjust one or more one or definitions for one or more event conditions. Additionally, in some embodiments, in response to adjusting one or more definitions, the component monitoring system 103 may analyze historical vehicle data 113 to determine and correct for false positive and/or false negative updates to the occurrence count 117 associated with the event to which the updated definition applies. For example, the component monitoring system may determine that historical vehicle data 113 associated with a prior detection of event occurrence fails to meet the adjusted definition for the event condition. In such contexts, the component monitoring system 103 may decrement the occurrence count 117, provision an alert to the computing device 105, and/or the like.

In some embodiments, the component monitoring system 103 is configured to reset one or more occurrence counts 117 in response to replacement of a component 106. In some embodiments, the component monitoring system 103 may receive from the vehicle management system 104, computing device 105, and/or the like an indication of replacement of one or more components 106. For example, the component monitoring system 103 may receive a communication comprising an identifier of a component 106 to be replaced and, optionally, a component identifier for a replacement component 106. In response, the component monitoring system 103 may reset the one or more occurrence counts 117 for the component 106 being replaced and reassign the occurrence counts 117 to the identifier associated with the replacement component 106. Alternatively, the component monitoring system 103 may retain the occurrence count 117 for the component 106 being replaced and generate a new occurrence count 117 associated with the replacement component 106. In some embodiments, the component monitoring system 103 is configured to determine that one or more occurrence counts 117 for a component 106 meet one or more predetermined thresholds for triggering replacement or servicing of the component 106. For example, in response to determining that an occurrence count 117 for excess braking force events exceeds a predetermined threshold, the component monitoring system 103 may provision to a computing device 105 a recommendation to replace or service one or more braking systems of a vehicle 101, one or more components 106 of the braking system, and/or the like.

In some embodiments, the component monitoring system 103 includes an apparatus 200 configured to perform various functions and actions related to enacting techniques and processes described herein for implementing persistent vehicle lifecycle data. In some embodiments, the component monitoring system 103 is configured to provide data to and receive data from one or more vehicles 101, one or more computing devices 105, and/or the like. In some embodiments, the component monitoring system 103 includes one or more data stores 107. The various data in the data store 107 may be accessible to one or more of the apparatus 200, the vehicle 101, and/or the like. The data store 107 may be representative of a plurality of data stores 107 as can be appreciated. The data stored in the data store 107, for example, is associated with the operation of the various applications, apparatuses, and/or functional entities described herein. The data stored in the data store 107 may include, for example, vehicle data 113, event data 115, occurrence counts 117, and/or the like.

In some embodiments, vehicle data 113 includes readings or statuses from one or more sensors, systems, and/or the like aboard the vehicle 101. For example, the vehicle data 113 may include measurements of temperature, pressure, fluid volume, flow rate, and/or the like that are associated with a component 106 or system within which the component 106 is implemented. As another example the vehicle data 113 may indicate a current or historical status of a component 106 or system, such as powered, depowered, underpowered, unresponsive, engaged, disengaged, disconnected, and/or the like. In some embodiments, vehicle data 113 includes identifiers for vehicles 101, systems of the vehicle 101, components 106 installed on the vehicle 101, and/or the like. In some embodiments, the vehicle data 113 includes threshold values or ranges of event occurrences, which may be utilized for determining when a component 106 should be serviced or replaced. For example, in the context of a hydraulic system or component 106 thereof, the vehicle data 113 may include a threshold quantity of clog events, overpressure events, overheat events, and/or the like. In such contexts, in response to determining a corresponding occurrence count 117 meets the threshold quantity, the component monitoring system 103 may provision to a computing device 105, vehicle management system 104, and/or the like, an instruction to service (e.g., inspect, repair, clean, and/or the like) or replace one or more associated components 106.

In some embodiments, event data 115 includes conditions, definitions, and/or the like for events that may be experienced or encountered by components 106 of a vehicle 101. For example, event data 115 may include a plurality of event conditions that may be experienced by a component of a hydraulic system. As another example, event data 115 may include a plurality of event conditions that may be experienced by an engine, braking system, landing gear, control interface, communication system, and/or the like. In various embodiments, event data 115 includes respective definitions for event conditions. A definition may comprise criteria (e.g., sensor readings, statuses, and/or the like) by which an event condition may be determined to be present, thereby denoting an occurrence of an event. For example, a definition may comprise a fault code, system message, and/or the like that, when observed or received, indicates a clog event, malfunction, and/or the like has occurred with respect to a component 106. As another example, a definition may comprise a threshold value or range for one or more types of sensor readings, such as temperature, power, pressure, moisture content, responsiveness, vehicle velocity, acceleration, shock, vibration, and/or the like.

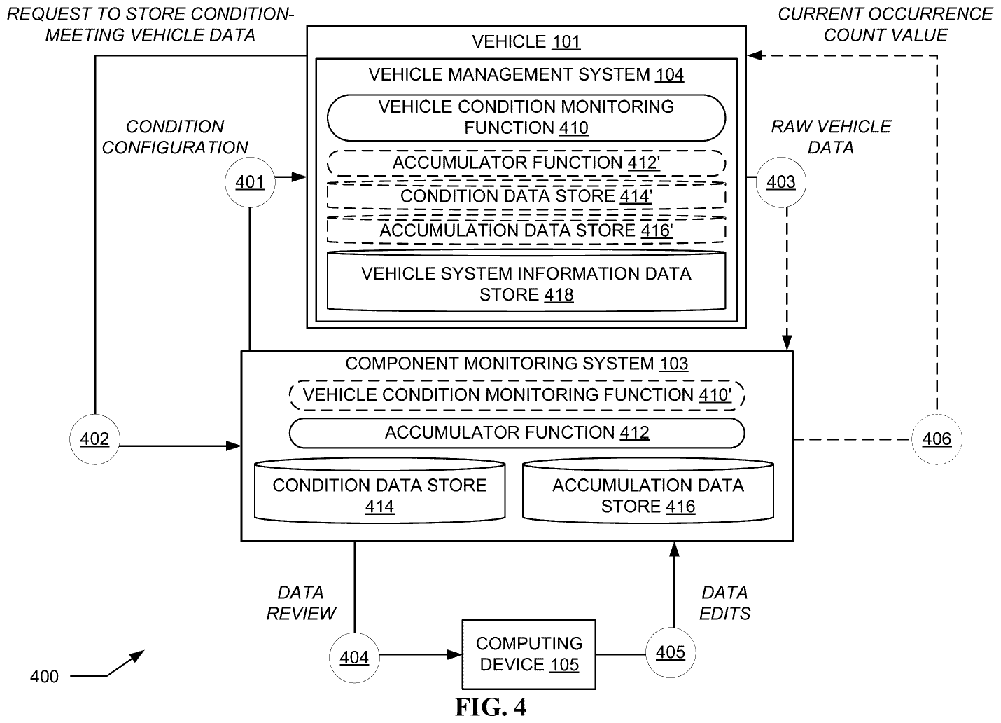

In some embodiments, the vehicle 101 includes a vehicle management system 104, a plurality of components 106, a plurality of sensors 108, and one or more data stores 109. In some embodiments, the vehicle management system 104 includes one or more vehicle recording systems configured to obtain and report one or more aspects of the vehicle or operation thereof. For example, the vehicle management system 104 may include a transponder, data uplink system, traffic collision avoidance system (TCAS), automatic dependent surveillance-broadcast (ADS-B), flight recorder, and/or the like. In some embodiments, the vehicle management system 104 includes any number of computing device(s) and/or other system(s) embodied in hardware, software, firmware, and/or the like that generate (or obtain from one or more sensors 108 or other systems of the vehicle 101) vehicle data 113′, determine that event conditions are met, provision alerts to the component monitoring system 103, and/or the like. For example, the vehicle management system 104 may include any number of computing device(s) and/or other system(s) embodied in hardware, software, firmware, and/or the like that perform condition detection and accumulator functions, as further shown in FIG. 4 and described herein. In some embodiments, the vehicle management system 104 includes one or more displays on which vehicle data 113′, event data 115′, occurrence counts 117, and/or the like may be rendered.

In various embodiments, a sensor 108 is configured to measure parameters, statuses, and/or the like of one or more components 106. For example, a sensor 108 may be configured to measure temperature, pressure, vibration, shock, position, power, and/or the like of a component 106. In another example, a sensor 108 may be configured to detect transition of a component 106 into one or more fault states, such as depowered, unresponsive, disconnected, clogged, and/or the like. In various embodiments, vehicle data 113, 113′ embodies outputs of the sensors 108, vehicle management system 104, and/or the like. For example, in the context of a hydraulic system, vehicle data 113, 113′ may comprise hydraulic fluid temperatures, hydraulic fluid pressures, clog detections, and/or the like.

In some embodiments, the data store 109 is configured to store vehicle data 113′. For example, the data store 109 may store measurements, detections, and/or the like from the sensors 108, vehicle management system 104, and/or the like. In some embodiments, the data store 109 is configured to store event data 115′. For example, the data store 109 may store respective definitions for one or more event conditions. In this manner, the vehicle management system 104 may determine whether one or more subsets of vehicle data 113′ meet a respective event condition for one or more events. In some embodiments, the data store 109 stores respective identifiers for components 106, sensors 108, and/or the like such that subsets of vehicle data 113′, event data 115′, and/or the like may be linked to a corresponding component 106, sensor 108, and/or the like for purposes of detecting events, reporting event occurrences, and maintaining the vehicle 101.

In some embodiments, the vehicle management system 104 is configured to receive and process vehicle data 113′ from one or more sensors 108 and other systems of the vehicle 101. For example, the vehicle data 113′ may comprise readings from one or more sensors 108 that indicate conditions, statuses, and/or the like of one or more components 106. The vehicle management system 104 may store the vehicle data 113′ at a data store 109. In some embodiments, the vehicle management system 104 provisions the vehicle data 113′, or one or more subsets of the vehicle data 113′, to the component monitoring system 103. By doing so, the vehicle management system 104 may enable the component monitoring system 103 to detect and record component-impacting events in substantially real-time. In this manner, the component monitoring system 103 may persistently update and maintain a record of respective events and conditions experienced by components 106 for their respective lifecycles.

Additionally, or alternatively, in some embodiments, the vehicle management system 104 determines that one or more subsets of the vehicle data 113′ meet a respective event definition for an event condition with which one or more components 106 are associated. In some embodiments, in response to determining the event condition is met by at least a subset of the vehicle data 113′, the vehicle management system 104 provisions at least the condition-satisfying subset of the vehicle data 113′ (or optionally all vehicle data 113′ within an interval comprising the detected event occurrence) to the component monitoring system 103. Additionally, or alternatively, in some embodiments, the vehicle management system 104 provisions to the component monitoring system 103 an indication that one or more event conditions for one or more components have been met. Based on the indication, the component monitoring system 103 may update a corresponding occurrence count 117 for the associated component 106 and respective event.

In some embodiments, the computing device 105 includes a personal computer, laptop, smartphone, tablet, Internet-of-Things enabled device, smart home device, virtual assistant, alarm system, workstation, work terminal, work portal, and/or the like. In some embodiments, the computing device 105 is configured to receive occurrence counts 117, vehicle data 113, event data 115, and/or the like from the component monitoring system 103, vehicle management system 104, and/or the like. In some embodiments, the computing device 105 includes one or more displays 119 by which data corresponding to one or more vehicles 101, components 106, occurrence counts 117, and/or the like is/are displayed to a user of the computing device 105. For example, the display 119 may include renderings of GUIs comprising respective occurrence counts 117 of one or more events for one or more components 106. In some embodiments, the display 119 includes a CRT (cathode ray tube), LCD (liquid crystal display) monitor, LED (light-emitting diode) monitor, touchscreen monitor, and/or the like, for displaying information/data to a user of the computing device 105.

In some embodiments, the computing device 105 includes one or more input devices for receiving user inputs, such as inputs for accessing or modifying occurrence counts 117, vehicle data 113, event data 115, and/or the like. For example, the computing device 105 may receive via an input device 121 a user input for incrementing or decrementing an occurrence count. As another example, the computing device 105 may receive a user input for adjusting a respective definition for one or more event conditions. In still another example, the computing device 105 may receive a user input for indicating installation of a new component 106, replacement of an installed component 106, and/or the like. In some embodiments, the input device 121 include one or more buttons, cursor devices, touch screens, including three-dimensional or pressure-based touch screens, camera, finger print scanners, accelerometer, retinal scanner, gyroscope, magnetometer, or other input devices.

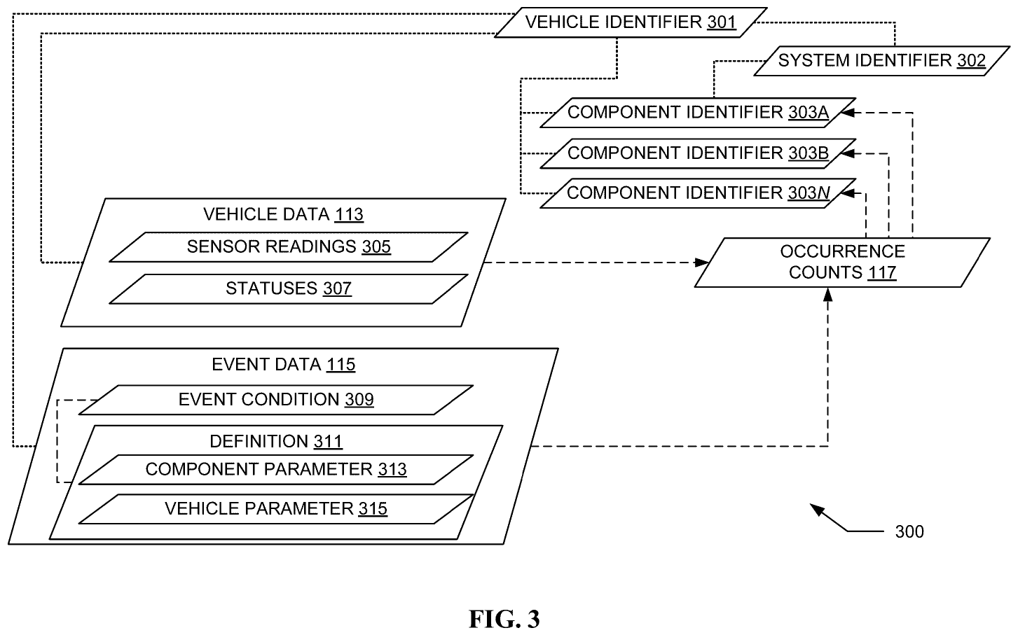

Additional example aspects of the vehicle data 113, 113′ and event data 115, 115′ are shown in the data architecture 300 depicted in FIG. 3 and described herein.

In some embodiments, the component monitoring system 103, vehicle 101, and computing device 105 are communicable over one or more communications network(s), for example the communications network(s) 150. It should be appreciated that the communications network 150 in some embodiments is embodied in any of a myriad of network configurations. In some embodiments, the communications network 150 embodies a public network (e.g., the Internet). In some embodiments, the communications network 150 embodies a private network (e.g., an internal, localized, and/or closed-off network between particular devices). In some other embodiments, the communications network 150 embodies a hybrid network (e.g., a network enabling internal communications between particular connected devices and external communications with other devices). In some embodiments, the communications network 150 embodies a satellite-based communication network. Additionally, or alternatively, in some embodiments, the communications network 150 embodies a radio-based communication network that enables communication between the apparatus 200, the vehicle 101, the computing device 105, and/or the like. For example, the apparatus 200 may provision event data 115 to and receive vehicle data 113 from a vehicle management system 104 via a transponder, communication gateway, and/or the like. The communications network 150 in some embodiments may include one or more transponders, satellites, base station(s), relay(s), router(s), switch(es), cell tower(s), communications cable(s) and/or associated routing station(s), and/or the like. In some embodiments, the communications network 150 includes one or more user-controlled computing device(s) (e.g., a user owner router and/or modem) and/or one or more external utility devices (e.g., Internet service provider communication tower(s) and/or other device(s)).

Each of the components of the system communicatively coupled to transmit data to and/or receive data from one another over the same or different wireless or wired networks embodying the communications network 150. Such configuration(s) include, without limitation, a wired or wireless Personal Area Network (PAN), Local Area Network (LAN), Metropolitan Area Network (MAN), Wide Area Network (WAN), satellite network, radio network, and/or the like. Additionally, while FIG. 1 illustrate certain system entities as separate, standalone entities communicating over the communications network 150, the various embodiments are not limited to this particular architecture. In other embodiments, one or more computing entities share one or more components, hardware, and/or the like, or otherwise are embodied by a single computing device such that connection(s) between the computing entities are over the communications network 150 are altered and/or rendered unnecessary.

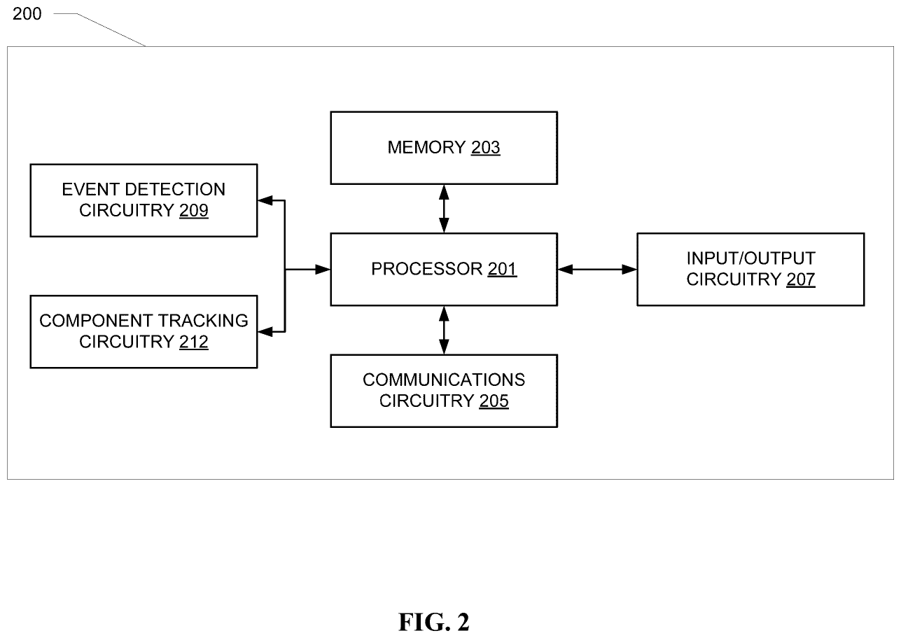

FIG. 2 illustrates a block diagram of an example apparatus 200 that may be specially configured in accordance with at least some example embodiments of the present disclosure. The apparatus 200 may carry out functionality and processes described herein to receive and process vehicle data, define event conditions, detect occurrences of events, maintain and update occurrence counts of events, cause rendering of occurrence counts on computing devices, and/or the like. In some embodiments, the apparatus 200 includes a processor 201, memory 203, communications circuitry 205, input/output circuitry 207, event detection circuitry 209, component tracking circuitry 212, and/or the like. In some embodiments, the apparatus 200 is configured, using one or more of the processor 201, memory 203, communications circuitry 205, input/output circuitry 207, event detection circuitry 209, component tracking circuitry 212, and/or the like, to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, controlling, modifying, restoring, processing, displaying, storing, determining, creating/generating, predicting, monitoring, evaluating, comparing, and/or similar terms used herein interchangeably. In one embodiment, these functions, operations, and/or processes may be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Additionally, or alternatively, in some embodiments, other elements of the apparatus 200 provide or supplement the functionality of another particular set of circuitry. For example, the processor 201 in some embodiments provides processing functionality to any of the sets of circuitry, the memory 203 provides storage functionality to any of the sets of circuitry, the communications circuitry 205 provides network interface functionality to any of the sets of circuitry, and/or the like.

In some embodiments, the processor 201 (and/or co-processor or any other processing circuitry assisting or otherwise associated with the processor) is/are in communication with the memory 203 via a bus for passing information among components of the apparatus 200. In some embodiments, for example, the memory 203 is non-transitory and may include, for example, one or more volatile and/or non-volatile memories. In other words, for example, the memory 203 in some embodiments includes or embodies an electronic storage device (e.g., a computer readable storage medium). In some embodiments, the memory 203 is configured to store information, data, content, applications, instructions, or the like, for enabling the apparatus 200 to carry out various functions in accordance with example embodiments of the present disclosure (e.g., detecting occurrences of events, updating and maintaining occurrence counts, and/or the like). In some embodiments, the memory 203 is embodied as a data store 107 or data store 109 as shown in FIG. 1 and described herein. In some embodiments, the memory 203 includes vehicle data, event data, occurrence counts and/or the like, as further architected in FIG. 3 and described herein.

The processor 201 may be embodied in a number of different ways. For example, in some embodiments, the processor 201 includes one or more processing devices configured to perform independently. Additionally, or alternatively, in some embodiments, the processor 201 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 201 is configured to execute instructions stored in the memory 203 or otherwise accessible to the processor. Additionally, or alternatively, the processor 201 in some embodiments is configured to execute hard-coded functionality. As such, whether configured by hardware or software methods, or by a combination thereof, the processor 201 represents an entity (e.g., physically embodied in circuitry) capable of performing operations according to an embodiment of the present disclosure while configured accordingly. Additionally, or alternatively, as another example in some example embodiments, when the processor 201 is embodied as an executor of software instructions, the instructions specifically configure the processor 201 to perform the algorithms embodied in the specific operations described herein when such instructions are executed.

As one particular example embodiment, the processor 201 is configured to perform various operations associated with implementing persistent lifecycle data for components of a vehicle. In some embodiments, the processor 201 includes hardware, software, firmware, and/or the like, that store vehicle data, event data, and occurrence counts in memory, configure definitions for event conditions at one or more vehicles, and/or the like. For example, the processor 201 may receive and store vehicle data from a vehicle management system 104, where one or more subsets of the vehicle data were determined to meet one or more event conditions. As another example, the processor 201 may store and modify definitions for event conditions.

In some embodiments, the apparatus 200 includes input/output circuitry 207 that provides output to a user (e.g., a maintaining entity or operating entity of a vehicle 101) and, in some embodiments, receives an indication of a user input. For example, in some contexts, the input/output circuitry 207 provides output to and receives input from one or more computing devices 105, vehicle management systems 104, and/or the like. In some embodiments, the input/output circuitry 207 is in communication with the processor 201 to provide such functionality. The input/output circuitry 207 may comprise one or more user interface(s) and in some embodiments includes a display that comprises the interface(s) rendered as a web user interface, an application user interface, a user device, a backend system, or the like. In some embodiments, the input/output circuitry 207 also includes a keyboard, a mouse, a joystick, a touch screen, touch areas, soft keys a microphone, a speaker, and/or other input/output mechanisms. The processor 201 and/or input/output circuitry 207 comprising the processor may be configured to control one or more functions of one or more user interface elements through computer program instructions (e.g., software and/or firmware) stored on a memory accessible to the processor 201 (e.g., memory 203, and/or the like). In some embodiments, the input/output circuitry 207 includes or utilizes a user-facing application to provide input/output functionality to a display of a computing device 105, vehicle management system 104, and/or other display associated with a user.

In some embodiments, the apparatus 200 includes communications circuitry 205. The communications circuitry 205 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 205 includes, for example, a network interface for enabling communications with a wired or wireless communications network, such as the network 150 shown in FIG. 1 and described herein. Additionally, or alternatively in some embodiments, the communications circuitry 205 includes one or more network interface card(s), antenna(s), bus(es), switch(es), router(s), modem(s), and supporting hardware, firmware, and/or software, or any other device suitable for enabling communications via one or more communications network(s). Additionally, or alternatively, the communications circuitry 205 includes circuitry for interacting with the antenna(s) and/or other hardware or software to cause transmission of signals via the antenna(s) or to handle receipt of signals received via the antenna(s). In some embodiments, the communications circuitry 205 enables transmission to and/or receipt of data from a vehicle management system 104, computing device 105, and/or other external computing devices in communication with the apparatus 200.

The event detection circuitry 209 includes hardware, software, firmware, and/or a combination thereof, that determine whether vehicle data meets definitions of one or more event conditions. For example, in some contexts, the event detection circuitry 209 includes hardware, software, firmware, and/or the like, that compare vehicle data to one or more definitions to determine whether the vehicle data is associated with occurrence of an event. In some embodiments, the event detection circuitry 209 includes hardware, software, firmware, and/or a combination thereof, that assign event definitions to respective components 106, vehicles 101, sensors 108 or other systems of the vehicle 101, and/or the like. In some embodiments, the event detection circuitry 209 includes hardware, software, firmware, and/or a combination thereof, that modifies definitions of event conditions based at least in part on user inputs, modifications to occurrence counts, and/or the like.

Additionally, or alternatively, in some embodiments, the event detection circuitry 209 includes hardware, software, firmware, and/or a combination thereof, that cause provision of event data (e.g., event conditions, definitions thereof, and/or the like) to a vehicle management system 104 to enable performance of event detection processes aboard a vehicle 101. In some embodiments, the event detection circuitry 209 is configured to verify an indication of event occurrence received from a vehicle management system. In some embodiments, the event detection circuitry 209 includes a separate processor, specially configured field programmable gate array (FPGA), and/or a specially programmed application specific integrated circuit (ASIC).

The component tracking circuitry 212 includes hardware, software, firmware, and/or a combination thereof, that initialize and maintain occurrence counts for tracking events experienced by components of a vehicle. For example, in some contexts, the component tracking circuitry 212 includes hardware, software, firmware, and/or the like, that initialize a respective occurrence count of one or more events for a component 106. In some embodiments, the component tracking circuitry 212 includes hardware, software, firmware, and/or the like, that update an occurrence count of a component 106 in response to a determination that vehicle data associated with the component 106 meets a respective definition for one or more event conditions. In some embodiments, the component tracking circuitry 212 includes hardware, software, firmware, and/or the like, that modify an occurrence count based at least in part on user input received at a computing device 105. In some embodiments, the component tracking circuitry 212 includes hardware, software, firmware, and/or the like, that reset one or more occurrence counts in response to replacement of a component. In some embodiments, the component tracking circuitry 212 includes hardware, software, firmware, and/or the like, that cause provision of occurrence counts, associated vehicle data, associated event data, and/or the like to a computing device 105. In some embodiments, the component tracking circuitry 212 includes hardware, software, firmware, and/or the like, that determine whether an occurrence count meets one or more predetermined thresholds for servicing a component, replacing a component, and/or the like. In some embodiments, the component tracking circuitry 212 includes a separate processor, specially configured field programmable gate array (FPGA), and/or a specially programmed application specific integrated circuit (ASIC).

Additionally, or alternatively, in some embodiments, two or more of the processor 201, memory 203, communications circuitry 205, input/output circuitry 207, event detection circuitry 209, and/or component tracking circuitry 212 are combinable. Additionally, or alternatively, in some embodiments, one or more of the sets of circuitry perform some or all of the functionality described associated with another component. For example, in some embodiments, two or more of the sets of circuitry 201-212 are combined into a single module embodied in hardware, software, firmware, and/or a combination thereof. Similarly, in some embodiments, one or more of the sets of circuitry, for example the memory 203, communication interface 205, event detection circuitry 209, and/or component tracking circuitry 212 is/are combined with the processor 201, such that the processor 201 performs one or more of the operations described above with respect to each of these sets of circuitry 203-212.

### Example Data Architecture and Data Flows of the Disclosure

Having described example systems and apparatuses in accordance with embodiments of the present disclosure, example architectures of data in accordance with the present disclosure will now be discussed. In some embodiments, the systems and/or apparatuses described herein maintain data environment(s) that enable the workflows in accordance with the data architectures described herein. For example, in some embodiments, the systems and/or apparatuses described herein function in accordance with the workflow 400 depicted in FIG. 4 and described herein. As another example, in some embodiments, the data architectures depicted and described herein with respect to FIG. 3 are maintained via the apparatus 200.

FIG. 3. illustrates an example data architecture 300 in accordance with at least some example embodiments of the present disclosure. In some embodiments, vehicle data 113, event data 115, and/or the like is associated with one or more identifiers that indicate the vehicle 101, vehicle system, component 106, and/or the like to which the data applies. For example, vehicle data 113, event data 115, and/or the like may be associated with a vehicle identifier 301, one or more system identifiers 302, one or more component identifiers 303A-N, and/or the like. In some embodiments, the component monitoring system 103 is configured to generate and remove associations between respective identifiers of components 106 and vehicles 101 in response to installation and replacement of the components 106.

In various embodiments, a vehicle identifier 301 uniquely identifies a vehicle 101. In some embodiments, a system identifier 302 uniquely identifies a system of a vehicle 101, which may comprise a plurality of components 106. For example, a system identifier 302 may be associated with a hydraulic system of a vehicle 101, and a component identifier 303A may be associated with a component 106 of the hydraulic system.

In various embodiments, a respective component identifier 303A-N uniquely identifies a component 106. For example, a component identifier 303A may uniquely identify a hydraulic press filter of a vehicle 101 with which the vehicle identifier 301 is associated. The component identifier 303A may be further associated with a system identifier 302 for a hydraulic system within which the component 106 is installed. As another example, a component identifier 303B may uniquely identify a fuel pump of the vehicle 101 and be associated with a second system identifier 302 for a fueling system of the vehicle 101.

In various embodiments, a component identifier is associated with one or more event conditions 309 representative of events that may be experienced by the corresponding component. For example, the component identifier 303A may be associated with one or more event conditions 309 representative of clogging. The component identifier 303A may be associated with additional event conditions 309 representative of other events, such as overpressure, overheating, and/or the like. In some embodiments, a component identifier is associated with one or more sensors 108 or other systems of the vehicle 101 configured to generate sensor readings 305 and statuses 307 associated with the component 106.

In various embodiments, a component identifier is associated with one or more occurrence counts 117. For example, a component identifier may be associated with a plurality of occurrence counts 117, where each occurrence count 117 is associated with a different event that may impact health or performance of the associated component 106. In some embodiments, an occurrence count 117 is associated with one or more event conditions 309, which may be detected based at least in part on vehicle data 113 and a definition 311. In some embodiments, an occurrence count 117 is associated with a component identifier for a lifecycle of the corresponding component 106. For example, the occurrence count 117 may be initialized at an instance in which the component 106 is originally installed in a vehicle 101. The occurrence count 117 may be maintained and updated until the component 106 is removed from the vehicle 101, after which the occurrence count 117 may be disassociated from the component 106 and reinitialized in association with a replacement component 106. In some embodiments, the occurrence count 117 is maintained in instances where the component 106 is removed from a first vehicle 101 and installed on a second vehicle 101. In some embodiments, event data 115 includes one or more thresholds that, when met, indicate a corresponding component 106 should be replaced, serviced, inspected, and/or the like.

In some embodiments, vehicle data 113 includes sensor readings 305, statuses 307, and/or the like with which a vehicle 101, one or more vehicle systems, one or more components 106, and/or the like are associated. In some embodiments, sensor readings 305 include measurements generated by sensors 108 aboard a vehicle 101. In various embodiments, sensor readings 305 include values of velocity, acceleration, temperature, pressure, force, torque, shock, vibration, flow rate, moisture level, volume, mass, expansion, contraction, extension, position, power consumption, and/or the like. In some embodiments, sensor readings 305 are associated with metadata including measurement timestamp, sampling frequency, sensor identifiers, component identifiers, system identifiers, vehicle identifiers, and/or the like. In some embodiments, the vehicle data 113 includes one or more metrics generated based at least in part on one or more sensor readings 305. For example, the vehicle data 113 may include averaged metrics, median metrics, calibrated metrics, compensated metrics, and/or the like.

In some embodiments, statuses 307 include operational states of components 106 or systems within which one or more components 106 are implemented. For example, a status 307 may indicate that a component 106 is clogged, depowered, underpowered, disconnected, unresponsive, and/or the like. As another example, a status 307 may indicate a level of wear, corrosion, breakage, and/or the like of a component 106. In another example, a status 307 may indicate brake engagement, landing gear deployment, automated steering activation, and/or the like. In some embodiments, the statuses 307 include error codes, fault codes, automated message, and/or the like that are generated by a system within which a component 106 is installed. For example, a status 307 may include an error code, fault code, error message, crew alert system (CAS) message and/or the like for interrupt register fail, roll torque failure, excessive roll rate, servo fail, brake failure, low hydraulic pressure, hydraulic overpressure, and/or the like.

Additionally, in some embodiments, sensor readings 305, statuses 307, and/or the like may include measurements or statuses generated by one or more sensors or systems remote from a vehicle 101. For example, sensor readings 305 may include measurements of vehicle attitude, velocity, acceleration, and/or the like that is generated by a primary radar system or other tracking means external to the vehicle 101. As another example, statuses 307 may include observations, analyses, and/or the like of component health from maintenance personnel, such as the level of wear of a component 106.

In some embodiments, event data 115 includes event conditions 309 and respective definitions 311 for the event conditions 309. In various embodiments, an event condition 309 is associated with an event such that a determination that the event condition 309 is (or was) present in a vehicle 101 or component 106 may correspond to detection of the associated event. In some embodiments, an event is associated with a combination of event conditions 309. For example, a hydraulic system failure event may be associated with a plurality of event conditions 309, where each event condition may be associated with failure of a different component 106 of a hydraulic system. In some embodiments, an event condition 309 is associated with a vehicle identifier 301, system identifier 302, one or more component identifiers, and/or the like.

In various embodiments, a definition 311 comprises one or more criteria for determining that vehicle data 113 meets an event condition 309. For example, a definition 311 may include one or more thresholds, triggers, and/or the like by which sensor readings 305, statuses 307, and/or the like may be verified as being indicative of an event condition 309. In some embodiments, a definition 311 comprises one or more equations into which vehicle data 113 may be inputted to determine whether the vehicle data meets an event condition 309. In some embodiments, an event condition 309 is associated with multiple definitions 311 such that occurrence of an event may be detected based on different combinations, types, and/or the like of vehicle data 113. In some embodiments, different definitions 311 associated with the same event condition 309 may be associated with different vehicle identifiers 301. In this manner, event detection may be based upon qualifying criteria that is specific to a particular vehicle model, vehicle type, vehicle configuration, and/or the like.

In some embodiments, a definition 311 includes thresholds for one or more component parameters 313, vehicle parameters 315, and/or the like. In some embodiments, a component parameter 313 refers to a property of a component 106. For example, a threshold for a component parameter 313 may include a value or range of temperature, pressure (e.g., oil pressure, hydraulic pressure, fuel pressure, and/or the like), moisture level, volume (e.g., fuel volume, oil volume, and/or the like), vibration, shock, torque, position, power consumption, and/or the like. In some embodiments, a vehicle parameter 315 refers to a property of a vehicle 101. For example, a threshold for a vehicle parameter 315 may include a value or range of attitude, speed, acceleration, braking, power consumption, and/or the like.

In some embodiments, event data 115 is stored in a data store onboard a vehicle 101. For example, the component monitoring system 103 may provision respective definitions 311 for a plurality of event conditions 309 such that a vehicle management system 104 may determine whether vehicle data 113 meets one or more event conditions 309. In such contexts, in response to determining that one or more subsets of vehicle data 113 meet one or more event conditions 309, the vehicle management system 104 may provision an indication of event occurrence to the component monitoring system 103, where the indication identifies the one or more events determined to have occurred. Additionally, in some embodiments, the vehicle management system 104 may provision to the component monitoring system 103 at least the one or more subsets of vehicle data 113 determined to have met the one or more vehicle conditions. Alternatively, in some embodiments, the component monitoring system 103 receives vehicle data 113 from the vehicle management system 104 in substantially real-time and determines whether the vehicle data 113 meets one or more event conditions 309.

FIG. 4 shows an example workflow 400 for implementing persistent vehicle lifecycle data. In some embodiments, the workflow 400 includes the component monitoring system 103 configuring one or more event conditions at a vehicle 101 (indicium 401). For example, the component monitoring system 103 may include a condition data store 414 comprising respective definitions 311 for one or more event conditions 309. The component monitoring system 103 may provision respective definitions 311 of one or more event conditions 309 to a vehicle management system 104 for storage in one or more data stores aboard the vehicle 101. In doing so, the component monitoring system 103 may enable the detection of component-impacting event conditions by the vehicle management system 104 and facilitate capture of event-associated vehicle data 113 in substantially real-time. In some embodiments, the vehicle management system 104 stores the definitions 311 in a condition data store 414′. In some embodiments, the vehicle management system 104 obtains and stores vehicle data 113 in a vehicle system information data store 418. In some embodiments, the vehicle system information data store 418 includes configuration data for associating an occurrence count 117 with one or more components 106, systems, and/or the like of the vehicle 101. In this manner, a vehicle operator, maintainer, and/or the like may correlate detected events to the one or more components 106, systems, and/or the like that are impacted by the events.

In some embodiments, the workflow 400 includes the vehicle management system 104 determining that one or more subsets of vehicle data 113 meets one or more event conditions 309. In some embodiments, the vehicle management system 104 includes a vehicle condition monitoring function 410 configured to determine that a subset of vehicle data 113 meets a respective definition 311 for one or more event conditions 309. For example, the vehicle condition monitoring function 410 compares vehicle data 113 from the vehicle system information data store 418 to definitions 311 from the condition data store 414′ to determine whether one or more event conditions 309 are met. In some embodiments, the vehicle management system 104 optionally includes an onboard accumulator function 412′ and accumulation data store 416′ configured to update and store occurrence counts 117 for respective events associated with the event conditions 309. The onboard accumulation data store 414′ may maintain the occurrence counts 117 for a lifecycle of the associated component 106. Alternatively, an offboard accumulator function 412 and accumulation data store 416 may maintain the occurrence counts 117 for a lifecycle of the vehicle 101. In some embodiments, the workflow 400 optionally includes the accumulator function 412′ updating one or more occurrence counts 117 at the accumulation data store 416′.

In some embodiments, the workflow 400 includes the component monitoring system 103 receiving from the vehicle 101 a request to store event condition-meeting vehicle data 113 (indicium 402). Additionally, or alternatively, in some embodiments, the vehicle management system 104 stores the vehicle data 113 in an accumulation data store 416′ onboard the vehicle 101. In various embodiments, the request indicates one or more event conditions 309 determined to have been met by a respective subset of the vehicle data 113. In some embodiments, the component monitoring system 103 provisions an acceptance of the request to the vehicle management system 104 and, in response, receives the one or more subsets of vehicle data 113. The component monitoring system 103 may store the one or more subsets of vehicle data 113 in an accumulation data store 416.

In some embodiments, the workflow 400 includes the component monitoring system 103, vehicle management system 104, and/or the like updating one or more occurrence counts 117. For example, the component monitoring system 103 may include an accumulator function 412 configured to increment one or more occurrence counts 117 at an accumulation data store 416 based at least in part on the one or more event conditions 309 determined to have been met. Additionally, or alternatively, the vehicle management system 104 may include an accumulator function 412′ configured to increment one or more occurrence counts 117 at an accumulation data store 416′ onboard the vehicle 101.

Alternatively, in some embodiments, the workflow 400 optionally includes the component monitoring system 103 receiving vehicle data 113 from the vehicle management system 104 to enable the component monitoring system 103 to determine whether one or more subsets of the vehicle data 113 meet one or more event conditions 309 (indicium 403). For example, the component monitoring system 103 may receive a continuous or asynchronous downstream of vehicle data 113 from the vehicle management system 104 via one or more gateway devices aboard the vehicle 101. In some embodiments, the workflow 400 optionally includes the component monitoring system 103 determining that one or more subsets of the vehicle data 113 meet one or more event conditions 309. For example, the component monitoring system 103 may include a vehicle condition monitoring function 410′ configured to compare vehicle data 113 and definitions 311 to determine whether one or more event conditions 309 are met. In response to determining that one or more event conditions 309 are met, an accumulator function 412 of the component monitoring system 103 may update one or more occurrence counts 117 for the one or more components 106 associated with the event conditions 309 and vehicle data 113.

In some embodiments, the workflow 400 includes the component monitoring system 103 provisioning one or more occurrence counts 117 to one or more computing devices 105 (indicium 404). For example, the component monitoring system 103 may cause the rendering of a graphical user interface (GUI) on a display of the computing device 105. Additionally, in some embodiments, the component monitoring system 103 provisions the one or more event conditions 309 determined to have been met. In some embodiments, the component monitoring system 103 further provisions to the computing device 105 the one or more subsets of vehicle data 113 determined to meet the one or more event conditions 309.

In some embodiments, the workflow 400 includes the component monitoring system 103 receiving one or more modifications to one or more occurrence counts 117 (indicum 405). For example, the computing device 105 may receive user input for incrementing or decrementing one or more occurrence counts 117. The component monitoring system 103 may receive from the computing device 105 one or more occurrence count modifications based at least in part on the user input. The modification to an occurrence count 117 may correct for a false positive, false negative, and/or the like. Additionally, or alternatively, in some embodiments, the component monitoring system 103 may receive from the computing device 105 a modification to one or more event definitions 311. The component monitoring system 103 may update an event definition 311b based at least in part on the modification. For example, the component monitoring system 103 may adjust a threshold value or range for one or more component parameters, vehicle parameters, and/or the like.

In some embodiments, the workflow 400 optionally includes the component monitoring system 103 provisioning to the vehicle 101 a respective current value of one or more occurrence counts 117. For example, the component monitoring system 103 may provision to the vehicle management system 104 a current value of an occurrence count 117 to cause the vehicle management system 104 to update a stored instance of the occurrence count 117 in an accumulation data store 416′. As another example, the component monitoring system 103 may cause rendering of a GUI comprising the current value of the occurrence count 117 on a display of the vehicle management system 104. Additionally, or alternatively, in some embodiments, the component monitoring system 103 provisions one or more modified definitions 311 to the vehicle management system 104. In doing so, the component monitoring system 103 may cause a vehicle condition monitoring function 410 to update or replace one or more stored instances of the definitions 311 at a condition data store 414′.

### Example Processes of the Disclosure

Having described example systems and apparatuses, data architectures, and data flows in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

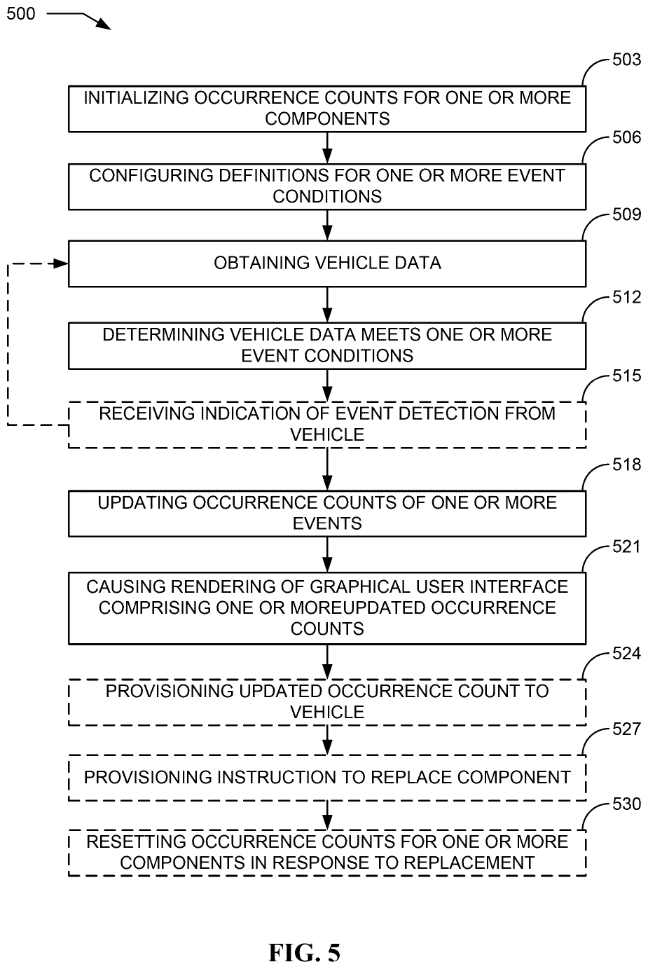

FIG. 5 illustrates a flowchart depicting operations of an example process 500 for implementing persistent vehicle lifecycle data in accordance with at least some example embodiments of the present disclosure. In some embodiments, the process 500 is embodied by computer program code stored on a non-transitory computer-readable storage medium of a computer program product configured for execution to perform the process as depicted and described. Additionally, or alternatively, in some embodiments, the process 500 is performed by one or more specially configured computing devices, such as apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 203 and/or another component depicted and/or described herein and/or otherwise accessible to the apparatus 200, for performing the operations as depicted and described.

In some embodiments, the apparatus 200 is in communication with one or more internal or external apparatus(es), system(s), device(s), and/or the like, to perform one or more of the operations as depicted and described. For example, the apparatus 200 may communicate with one or more vehicle management systems 104, one or more computing devices 105, and/or the like to perform one or more operations of the process 500.

At operation 503, the apparatus 200 includes means such as the event detection circuitry 209, the component tracking circuitry 212, the communications circuitry 205, the input/output circuitry 207, the processor 201, or a combination thereof, that initialize one or more occurrence counts 117 for one or more components installed aboard a vehicle 101. In some embodiments, the apparatus 200 initializes an occurrence count 117 of each event condition 309 of a respective component 106 to a value of 0.

In some embodiments, a component 106 that has experienced one or more cycles of utilization (e.g., a non-pristine component) may be associated with one or more historical counts of occurrences respective events experienced by the component 106 during its prior usage. In some embodiments, the apparatus 200 obtains one or more historical occurrence counts 117 for a component 106 that has previously been installed on another vehicle 101. For example, the component 106 may be a used part, system, and/or the like, that is recycled from a first vehicle 101 to a second vehicle 101. A historical occurrence count 117 may record a quantity of instances in which the component 106 experienced an event while installed on the first vehicle 101. The apparatus 200 may generate a new occurrence count 117 for the used component 106 in association with the current vehicle 101 within which the component 106 is installed. The apparatus 200 may increment the new occurrence count instance based at least in part on the quantity of event detections indicated by the one or more historical occurrence counts 117. In some embodiments, the apparatus 200 maintains the occurrence counts 117 for a lifecycle of the component 106, a lifecycle of the vehicle 101, and/or the like. In some embodiments, the apparatus 200 causes the vehicle management system 104 to initialize duplicate instances of one or more occurrence counts 117 in a data store aboard the vehicle 101 such that updated counts of component-impacting events may be retained aboard the vehicle 101.

At operation 506, the apparatus 200 includes means such as the event detection circuitry 209, the component tracking circuitry 212, the communications circuitry 205, the input/output circuitry 207, the processor 201, or a combination thereof, that configure a respective definition 311 for one or more event conditions 309. In some embodiments, the apparatus 200 obtains a definition 311 for an event condition 309 from a computing device 105. For example, the apparatus 200 may receive from a computing device 105 a plurality of component identifiers and respective definitions 311 for one or more event conditions 309 that may be experienced by components 106 associated with the component identifiers. Additionally, or alternatively, in some embodiments, the apparatus 200 receives from a vehicle management system 104 one or more component identifiers. The apparatus 200 may retrieve one or more stored definitions 311 from one or more datastores such that the definitions 311 may be subsequently utilized for event condition detection functions performed by the apparatus 200, the vehicle management system 104, and/or the like.

In some embodiments, at operation 506, the apparatus 200 optionally includes means such as the event detection circuitry 209, the component tracking circuitry 212, the communications circuitry 205, the input/output circuitry 207, the processor 201, or a combination thereof, that provision one or more definitions 311 to a vehicle management system 104 of the vehicle 101. In doing so, the apparatus 200 may configure the vehicle management system 104 to monitor for occurrences of component-impacting event by detecting instances in which vehicle data 113 meets one or more definitions 311.

At operation 509, the apparatus 200 includes means such as the event detection circuitry 209, the component tracking circuitry 212, the communications circuitry 205, the input/output circuitry 207, the processor 201, or a combination thereof, that obtain vehicle data 113 associated with operation of the vehicle 101. In some embodiments, operation 509 includes the vehicle management system 104 of the vehicle 101 obtaining sensor readings 305, statuses 307, and/or the like from one or more sensors 108, systems, and/or the like. In some embodiments, at operation 509, the apparatus 200 obtains vehicle data 113 from the vehicle 101. For example, the apparatus 200 may receive all or a subset of vehicle data 113 obtained by the vehicle management system 104. In this manner, the apparatus 200 may process the raw vehicle data 113 in a computing environment external to the vehicle 101 and determine if one or more definitions 311 are met.

Alternatively, in some embodiments, the apparatus 200 receives a subset of vehicle data 113 determined by the vehicle management system 104 to meet one or more definitions 311. For example, at operation 512 (which may occur asynchronously to operation 509), the vehicle management system 104 may determine that a subset of vehicle data 113 meets a respective definition 311 for one or more event conditions 309. In such contexts, at operation 515, the apparatus 200 may receive an indication that one or more event conditions 309 were met. Further, at operation 509, the apparatus 200 may receive from the vehicle management system 104 at least the subset of vehicle data 113 determined to have met one or more definitions 311.

At operation 512, the apparatus 200 includes means such as the event detection circuitry 209, the component tracking circuitry 212, the communications circuitry 205, the input/output circuitry 207, the processor 201, or a combination thereof, that determine that one or more subsets of vehicle data 113 meet a respective definition 311 for one or more event conditions 309. For example, the apparatus 200 may determine that a subset of vehicle data 113 received from the vehicle 101 meets a respective threshold for one or more component parameters. In this manner, the apparatus 200 may comprise a computing environment that is external to the vehicle 101 and configured to determine satisfaction of event conditions based on received vehicle data 113 and corresponding definitions 311. Alternatively, or additionally, in some embodiments, the vehicle management system 104 determines that vehicle data 113 meets one or more definitions 311.

At operation 515, the apparatus 200 optionally includes means such as the event detection circuitry 209, the component tracking circuitry 212, the communications circuitry 205, the input/output circuitry 207, the processor 201, or a combination thereof, that receive from the vehicle management system 104 an indication that one or more event conditions were met. In some embodiments, the apparatus 200 further receives at least the subset of vehicle data 113 determined to have met the one or more definitions 311 (operation 509).

Additionally, in some embodiments, the apparatus 200 receives a first set of vehicle data 113 associated with detection of the event condition 309 and one or more additional sets of vehicle data 113 associated with a buffer interval preceding detection of the event condition 309 (e.g., 10 seconds prior, 1 minute prior, 1 hour prior, or another suitable interval). In some embodiments, the apparatus 200 receives a first set of vehicle data 113 corresponding to the component 106 with which the event condition 309 is associated. The apparatus 200 may further receive one or more additional sets of vehicle data 113 corresponding to the time interval within which the event condition 309 was detected and which are associated with one or more additional components 106, systems, and/or the like. For example, a clogging event may be detected in a left hydraulic press return. In such contexts, the apparatus 200 may receive a first set of vehicle data 113 associated with the clogged left hydraulic return filter and a second set of vehicle data 113 associated with other components of the same hydraulic system and the same time interval, such as a left hydraulic press filter, right hydraulic return filter, left auxiliary press filter, hydraulic fluid, and/or the like.

At operation 518, the apparatus 200 includes means such as the event detection circuitry 209, the component tracking circuitry 212, the communications circuitry 205, the input/output circuitry 207, the processor 201, or a combination thereof, that update one or more occurrence counts 117 based at least in part on the one or more event conditions 309 determined to have been met. For example, the apparatus 200 may determine an occurrence count 117 associated with the event condition 309 determined to have been met. The apparatus 200 may increment the occurrence count 117 by the number of instances of the event condition 309 determined to have been experienced by the component 106.

In some embodiments, the apparatus 200 receives a quantity of event condition detections from the vehicle management system 104 and updates one or more occurrence counts 117 based thereon. For example, at operation 515, the apparatus 200 may receive from the vehicle management system 104 an indication that one or more event conditions 309 were met for one or more components 106. The indication may further comprise a respective quantity of detections for the one or more event conditions 309. The apparatus 200 may determine an occurrence count 117 associated with the event condition 309 and update the occurrence count 117 based at least in part on the quantity of detections.

At operation 521, the apparatus 200 includes means such as the event detection circuitry 209, the component tracking circuitry 212, the communications circuitry 205, the input/output circuitry 207, the processor 201, or a combination thereof, that cause rendering of a graphical user interface (GUI) on one or more computing devices 105. The computing device 105 may be remote from the apparatus 200, the vehicle 101, and/or the like. For example, the computing device 105 may be a device associated with a maintainer of the vehicle 101, an inventory manager, a risk assessor, and/or the like. The GUI may comprise the one or more updated occurrence counts 117 of operation 518. For example, the apparatus 200 may provision to a computing device 105 the one or more updated occurrence counts 117, which may cause the computing device 105 to render a GUI on a display 119 thereof. In some embodiments, the apparatus 200 causes rendering of one or more event conditions 309 on the computing device 105, where the one or more event conditions 309 may be associated with the updated occurrence counts 117. In some embodiments, the GUI further comprises additional occurrence counts 117 for the component 106 with which the updated occurrence count 117 is associated. In this manner, the apparatus 200 may provide a holistic overview of component health to a vehicle maintainer, operator, and/or the like.

Additionally, or alternatively, in some embodiments, the apparatus 200 generates and provisions to the computing device 105 a vehicle report comprising respective current occurrence counts 117 for one or more components 106 of the vehicle 101. For example, the apparatus 200 may generate a report comprising a component identifier for each component 106 installed within a vehicle 101 or one or more systems thereof. The report may further comprise current values of the occurrence counts 117 for each component 106 identified. In some embodiments, the apparatus 200 provisions the report to the vehicle management system 104 to cause storage of the report aboard the vehicle 101. In this manner, the apparatus 200 may persistently maintain and update a record of component-impacting events onboard the vehicle 101 and/or in a computing environment external to the vehicle 101.

At operation 524, the apparatus 200 optionally includes means such as the event detection circuitry 209, the component tracking circuitry 212, the communications circuitry 205, the input/output circuitry 207, the processor 201, or a combination thereof, that provision one or more updated occurrence counts 117 to the vehicle 101. For example, the apparatus 200 may provision to a vehicle management system 104 one or more updated occurrence counts 117. In doing so, the apparatus 200 may cause the vehicle management system 104 to render on a display aboard the vehicle 101 the one or more updated occurrence counts 117. Additionally, in some embodiments, the apparatus 200 provisions to the vehicle 101 one or more event conditions 309 determined to have been met by the one or more subsets of vehicle data 113.

In some embodiments, the process 500 includes generating a report of a plurality of components 106 of a vehicle 101 and provisioning the report to a computing device 105, vehicle management system 104, and/or the like. For example, the apparatus 200 may receive from the computing device 105 a vehicle identifier, a system identifier, and/or the like. The apparatus 200 may determine a plurality of components 106 associated with the vehicle identifier or the system identifier. The apparatus 200 may retrieve a respective current occurrence count 117 for one or more event conditions 309 associated with a respective component 106. The apparatus 200 may provision to the computing device 105 (or vehicle management system 104) a report comprising the respective current occurrence counts 117 of the one or more event conditions 309 for the plurality of components 106. Additionally, in some embodiments the apparatus 200 generates a ranking of the plurality of components 106 based at least in part on the respective current occurrence counts 117, where a top-ranked entry of the ranking is associated with a component having a greatest quantity of occurrences of one or more event conditions. The apparatus 200 may provision to the computing device 105 the complete ranking or a respective component identifier for a top-ranked subset of the ranking.

At operation 527, the apparatus 200 optionally includes means such as the event detection circuitry 209, the component tracking circuitry 212, the communications circuitry 205, the input/output circuitry 207, the processor 201, or a combination thereof, that provision to the vehicle 101, computing device 105, and/or the like an instruction to replace one or more components 106 of the vehicle 101. In some embodiments, the apparatus 200 determines that an updated value of an occurrence count 117 meets a replacement threshold. For example, the apparatus 200 may determine that an occurrence count 117 of clog events for a hydraulic return filter meets a predetermined value or range. In some embodiments, the apparatus 200 provisions to a computing device 105, vehicle management system 104, and/or the like an instruction to replace the component 106 associated with the threshold-satisfying occurrence count 117. In some embodiments, the instruction includes a component identifier, current value of the occurrence count 117, associated event condition 309, and/or the like.

Additionally, or alternatively, in some embodiments, the process 500 includes the apparatus 200 determining that the updated value of the occurrence count 117 meets a maintenance threshold. In some embodiments, in response to the determination, the apparatus 200 provisions to a computing device 105 an instruction to service (e.g., clean, repair, inspect, and/or the like) the component 106 associated with the occurrence count 117.

At operation 530, the apparatus 200 optionally includes means such as the event detection circuitry 209, the component tracking circuitry 212, the communications circuitry 205, the input/output circuitry 207, the processor 201, or a combination thereof, that reset one or more occurrence counts 117 in response to replacement of a component 106 of the vehicle 101. For example, the apparatus 200 may receive from a vehicle management system 104, computing device 105, and/or the like, a notification of replacement of one or more components 106. In some embodiments, the notification includes one or more component identifiers, vehicle identifiers, system identifiers, and/or the like. In some embodiments, based at least in part on the notification, the apparatus 200 resets one or more occurrence counts 117 associated with the replaced component. Additionally, in some embodiments, the apparatus 200 disassociates the occurrence count 117 from a component identifier associated with the replacement component 106 and generates a new association between the occurrence count 117 and a component identifier associated with the replacement component 106. In some embodiments, the apparatus 200 resets the occurrence count 117 to a value of 0 (e.g., in instances of installing a new component 106). Alternatively, in some embodiments, the apparatus 200 obtains one or more historical occurrence counts 117 associated with the replacement component 106. The apparatus 200 may generate and store an association between the historical occurrence counts 117 and a vehicle identifier for the vehicle 101 within which the replacement component 106 is being installed, after which the apparatus 200 may update the occurrence counts 117 based on events detected on the vehicle 101.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
initializing, in at least one data store, a count of occurrences of a respective event associated with at least one event condition for a component installed on a vehicle, wherein the count of occurrences of the respective event is maintained at the data store for a lifecycle of the component;
storing, in the at least one data store, a respective definition for the at least one event condition;
obtaining, from at least one sensor or system aboard the vehicle, vehicle data associated with operation of the vehicle;
determining that at least a subset of the vehicle data meets the at least one event condition for the component;
in response to the determination, updating the count of occurrences of the respective event at the at least one data store; and
causing rendering of the updated count of occurrences on a computing device external to the vehicle to enable maintenance monitoring of the component.

2. The method of claim 1, further comprising:
resetting the count of occurrences of the respective event in the at least one data store in response to replacement of the component.

3. The method of claim 2, further comprising:
obtaining a value of at least one historical count of occurrences of the respective event for a replacement component; and
updating the count of occurrences of the respective event based at least in part on the value of the at least one historical count of occurrences.

4. The method of claim 1, wherein:
the at least one data store comprises a first data store aboard the vehicle and a second data store remote to the vehicle;
the first data store comprises the respective definition for the at least one event condition; and
the second data store comprises the count of occurrences of the respective event for the component.

5. The method of claim 4, further comprising:
provisioning to the vehicle the respective definition for the at least one event condition; and
receiving from the vehicle at least the subset of the vehicle data determined to meet the at least one event condition for the component.

6. The method of claim 1, further comprising:
determining the updated count of occurrences for the respective event for the component meets a replacement threshold; and
in response to the determination, provisioning to the computing device an instruction to replace the component.

7. The method of claim 1, further comprising:
receiving from the computing device a request comprising at least one of an increment or a decrement to the updated count of occurrences; and
modifying the updated count of occurrences based at least in part on the request.

8. The method of claim 1, further comprising:
receiving from the computing device a request comprising at least one modification to the respective definition for the at least one event condition; and
updating the respective definition based at least in part on the at least one modification.

9. An apparatus comprising at least one processor and at least one non-transitory memory having computer-coded instructions stored thereon that, in execution with at least one processor, cause the apparatus to:
initialize, in at least one data store, a count of occurrences of a respective event associated with at least one event condition for a component installed on a vehicle, wherein the count of occurrences of the respective event is maintained at the data store for a lifecycle of the component;
store, in the at least one data store, a respective definition for the at least one event condition;
obtain, from at least one sensor or system aboard the vehicle, vehicle data associated with operation of the vehicle;
determine that at least a subset of the vehicle data meets the at least one event condition for the component;
in response to the determination, update the count of occurrences of the respective event at the at least one data store; and
cause rendering of the updated count of occurrences on a computing device external to the vehicle to enable maintenance monitoring of the component.

10. The apparatus of claim 9, wherein:
the at least one data store comprises a first data store aboard the vehicle and a second data store remote to the vehicle;
the first data store comprises the respective definition for the at least one event condition; and
the second data store comprises the count of occurrences of the respective event for the component; and
the computer-coded instructions, in execution with the at least one processor, further cause the apparatus to:
initialize the respective definition at the first data store to cause a vehicle management system aboard the vehicle to provision the vehicle data to the apparatus in response to the vehicle data meeting a least a portion of the respective definition for the at least one event condition.

11. The apparatus of claim 9, wherein:
the respective definition indicates at least one threshold for at least one component parameter.

12. The apparatus of claim 11, wherein:
the at least one component parameter comprises a fault state for the component.

13. The apparatus of claim 12, wherein:
the fault state comprises at least one of depowered, underpowered, or clogged.

14. The apparatus of claim 11, wherein:
the at least one component parameter comprises at least one of hydraulic pressure, oil pressure, moisture level, or temperature.

15. The apparatus of claim 11, wherein:
the at least one component parameter comprises at least one of applied load, torque, shock intensity, vibration intensity, vibration frequency, or vibration duration.

16. The apparatus of claim 9, wherein:
the respective definition indicates at least one threshold for at least one of vehicle attitude, vehicle speed, or braking.

17. The apparatus of claim 9, wherein:
the computer-coded instructions, in execution with the at least one processor, further cause the apparatus to:
provision to the vehicle the updated count of occurrences.

18. The apparatus of claim 9, wherein:
the computer-coded instructions, in execution with the at least one processor, further cause the apparatus to:
receive from the computing device at least one of a vehicle identifier or a system identifier;
determine a plurality of components associated with the vehicle identifier or the system identifier;
retrieve, from the at least one data store, a current count of occurrences for at least one event condition associated with a respective component; and
provision to the computing device a report comprising the respective current counts of occurrences of the at least one event condition for the plurality of components.

19. The apparatus of claim 18, wherein:
the computer-coded instructions, in execution with the at least one processor, further cause the apparatus to:
generate a ranking of the plurality of components based at least in part on the respective current counts of occurrences of the at least one condition, wherein a top-ranked entry of the ranking comprises a component associated with a greatest quantity of occurrences of the at least one event condition; and
provision to the computing device a respective component identifier for a top-ranked subset of the ranking.

20. A computer program product comprising at least one non-transitory computer-readable storage medium having computer program code stored thereon that, in execution with at least one processor, is configured to:
initialize, in at least one data store, a count of occurrences of a respective event associated with at least one event condition for a component installed on a vehicle, wherein the count of occurrences of the respective event is maintained at the data store for a lifecycle of the component;
store, in the at least one data store, a respective definition for the at least one event condition;
obtain, from at least one sensor or system aboard the vehicle, vehicle data associated with operation of the vehicle;
determine that at least a subset of the vehicle data meets the at least one event condition for the component;
in response to the determination, update the count of occurrences of the respective event at the at least one data store; and
cause rendering of the updated count of occurrences on a computing device external to the vehicle to enable maintenance monitoring of the component.
